(19) United States
(12) Patent Application Publication
(10) Pub. No.: US 2015/0343489 A1
(43) Pub. Date: Dec. 3, 2015

(54) Methods of Producing Food Containers With An Antimicrobial Coating

(71) Applicant: The United States of America, as Represented by the Secretary of Agriculture, Washington, DC (US)

(72) Inventors: Lin S. Liu, Blue Bell, PA (US); Zhonglin T. Jin, North Wales, PA (US)

(21) Appl. No.: 14/287,672

(22) Filed: May 27, 2014

(51) Int. Cl. B05D 3/00

(52) U.S. Cl. CPC B05D 3/007

(57) ABSTRACT

Methods of producing food containers with an antimicrobial coating, involving (a) applying a composition containing zein and a carrier (e.g., ethanol) to a food container and drying the food container, and (b) subsequently applying to the food carrier a composition containing a binder (e.g., zein), a carrier (e.g., ethanol), and at least one compound selected from TiO₂, metal doped TiO₂, nonmetal doped TiO₂, and mixtures thereof, and drying the food container.

### BACKGROUND OF THE INVENTION

Methods of producing food containers with an antimicrobial coating are disclosed, involving (a) applying a composition containing zein and a carrier (e.g., ethanol) to a food container and drying the food container, and (b) subsequently applying to the food carrier a composition containing a binder (e.g., zein), a carrier (e.g., ethanol), and at least one compound selected from TiO₂, metal doped TiO₂, nonmetal doped TiO₂, and mixtures thereof, and drying the food container.

The fruit agribusiness contributes more than $9 billion annually to the US economy. About 59% of apple and 37% of all non-citrus fruits (e.g., peach, plum, grape, cherry, etc.) are consumed by Americans without processing (U.S.A. fruit production statistics, http://www.usda.gov/nass/aggraphs/fruit.htm). Eating fresh produce adds to the quality of life, and fresh fruits and vegetables are important components of a healthy and balanced diet to protect from and fight against a wide range of illnesses, such as diabetes, cancers, high blood pressure, obesity, and cardiovascular diseases. With an increase in the awareness of the advantages of fresh foods over processed foods, and at the encouragement of government health agencies and social organizations, the consumption of fresh fruits and raw vegetables has increased in industrial countries and post-industrial countries (Wells, H. F., and J. C. Buzby, 2008, Dietary Assessment of Major Trends in U.S. Food Consumption, 1970-2005, Economic Information Bulletin No. (EIB-33), 27 pp, Economic Research Service, U.S. Department of Agriculture; NPC, LLC: Produce market report. http://www.nproduce.com). Meanwhile, the risk of digestive diseases associated with the consumption of produce has also increased. Some outbreaks of illnesses have been linked to the consumption of fruit and vegetable products contaminated with Escherichia coli O157:H7 (Centers for Disease Control and Prevention, 2011, Investigation Announcement: Multistate Outbreak of E. coli O157:H7 Infections Linked to Romaine Lettuce, http://www.cdc.gov/ecoli/2011/ecoliO157/romainelettuce/120711/index.html; Beuchat, L. R., et al., J. Food Prot., 61: 1305-1311 (1998); Anonymous, Ann. Emerg. Med., 29: 645-646 (1996)). Fruit and vegetable contamination can occur in the field or at the postharvest stage. Foodborne pathogens could establish themselves on growing fruits and vegetables from contaminated irrigation water, flies, insects, and soil, or from raw animal manure, sewage, etc. The contaminants could be amplified postharvest by the proliferation of the pathogens, or by cross-contamination from infected workers, agricultural materials, or equipment used during harvest and storage, such as container or shelves (Lynch, M. F. R., et al., Epidemiol. Infect. 137: 307-315 (2009); Sapers, G., Solomon, E., Matthews, K. R. (ed.), 2009, The Produce Contamination Problem: Causes and Solutions, Academy Press, Burlington, Mass.; Langholz, J. A., M. T. Jay-Russell, Human-Wildlife Interactions, 7(1):140-157 (2013)). Containers are used for the collection of fruits and vegetables in fields, their transportation, and storage in warehouses and retail rooms. Containers and shelves, either made from cellulosic materials (such as cardboards, baskets and boxes from bamboo or wood), plastics or metals, seldom are disinfected or rarely have self-sterilizing functions. They may provide an additional route for transmission of pathogens and spoilage organisms, once they are contaminated.

Titanium dioxide (TiO₂) has strong killing effect on all kinds of bacteria under UV irradiation, while metal (e.g., Cu, Co, Ni, Cr, Mn, Mo, Nb, V, Fe, Ru, Au, Ag, Pt) doped-TiO₂ and nonmetal (e.g., N, S, C, B, P, I, F) doped-TiO₂ exhibit high antibacterial activity even under visible light (Langholz, J. A., M. T. Jay-Russell, Human-Wildlife Interactions, 7(1):140-157 (2013); Augugliaro, V., et al., J. Photochemistry and Photobiology C: Photochmistry Reviews, 13:224-245 (2012); Pelaez, M., et al., Applied Catalysis B: Environmental, 15:331-349 (2012); Kedziora, A., et al., J. Sol-Gel Science & Technology, 62:79-86 (2012); Roy, A., et al., J. Biomaterials and Nanotechnology, 1:37-41 (2010)). Due to their chemical stability, non-toxicity to mammals, and the capability to be repeatedly used without losing activity, these inorganic compounds have been used as disinfection or sterilization reagents for water and air purification, self-clean solid surfaces, and food protection.

We have found that zein (a protein isolated from corn gluten meal, the byproduct of corn wet milling) and paint formulations can be used as binder materials for TiO₂ coatings and that these coatings inhibit bacteria growth.

### SUMMARY OF THE INVENTION

Methods of producing food containers with an antimicrobial coating, involving (a) applying a composition containing zein and a carrier (e.g., ethanol) to a food container and drying the food container, and (b) subsequently applying to the food carrier a composition containing a binder (e.g., zein), a carrier (e.g., ethanol), and at least one compound selected from TiO₂, metal doped TiO₂, nonmetal doped TiO₂, and mixtures thereof, and drying the food container.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1(A) as described below shows SEM photographs of zein, showing a glossy and pretty uniform morphology without pore (Z1) even at high magnification (Z2); the appearance of its cross-sections is dense and smooth, indicating the plastic nature of zein (Z3, Z4). Magnification: Z1 and Z3, 5K; Z2 and Z4, 200K. FIG. 1(B) as described below shows SEM photographs of single layered film from zein and TiO₂ powders, showing a rough morphology in the surface (S1, S2) and on the fractured cross-section (S3, S4) due to the incorporation of TiO₂ nanoparticles. The particles were glued together by zein to form blocks. Magnification: S1 and S3, 5K; S2 and S4, 200K. FIG. 1(C) as described below shows SEM photographs of double layered film from zein and TiO₂/zein, showing a rough morphology in the surface (D1, D2) due to the incorporation of TiO₂ nanoparticles. The cross-section shows a TiO₂-free layer in the bottom and a TiO₂-embedded layer in the top (D3, D4). Magnification: D1 and D3, 5K; D2 and D4, 200K.

FIG. 2 shows effect of TiO₂ concentration in coating on growth of E. coli O157:H7 after 3 (blue column) and 18 h (red column) inoculation at 22° C. as described below. All samples were placed under light for 18 h. Control: no coating. Each tested Petri dish coated with 10 ml TiO₂/zein formulation. The ratio of TiO₂/zein in sample #0: 0 (neat zein); sample #1: 1%; sample #2: 2%; sample #3: 10%; sample #2⁺: bilayered film, 8 ml neat zein in bottom and 2 ml of sample #2 on top. Error bars represent the standard deviation of the mean.

FIG. 3 shows effect of visible light irradiation on growth of E. coli O157:H7 on TiO₂/zein coatings (2%) after 3 (blue column) and 18 h (red column) at 22° C. as described below. Sample #2: under light for 15 h and then in dark for 3 h; sample #2⁻: under light for 3 h and then in dark for 15 h; sample #2⁺⁺: replacing TiO₂ with codoped-TiO₂, under light for 3 h and then at dark for 15 h. Error bars represent the standard deviation of the mean.

FIG. 4 shows E. coli O157:H7 colonies on the surface of coated petri dishes after washing as described below. Each petri dish coated with 10 ml zein formulations. A: Sample #2⁺: bilayered film, 8 ml neat zein in bottom and 2 ml TiO₂/zein (2%) on top (under light for 15 h and then in dark for 3 h); B: Sample #2: TiO₂/zein (2%, under light for 15 h and then in dark for 3 h); C: Sample #2⁻: TiO₂/zein (2%, under light for 3 h and then in dark for 15 h); D: Sample #0: coating with neat zein (under light for 15 h and then in dark for 3 h).

FIG. 5 shows survival of E. coli O157:H7 on the surface of metal disks as described below. Sample disks under light for 3 h (A) and 18 h (B). No-coating: a disk without any coating; Control: coated disk without TiO₂; CW0-5: Coated disk being washed in water for 0 to 5 times. *: under detectable limit (<1.0 log/CFU). Error bars represent the standard deviation of the mean. Data having a common letter are not significantly different (p>0.05).

FIG. 6 shows measurement of water vapor permeability of filter papers, the papers coated with zein, or zein and TiO₂ (1%) blends as described below.

### DETAILED DESCRIPTION OF THE INVENTION

Disclosed herein are methods of producing food containers with an antimicrobial coating, involving (a) applying a composition containing zein and a carrier (e.g., ethanol) to a food container and drying the food container, and (b) subsequently applying to the food carrier a composition containing a binder (e.g., zein), a carrier (e.g., ethanol), and at least one compound selected from TiO₂, metal doped TiO₂, nonmetal doped TiO₂, and mixtures thereof, and drying the food container. The content of TiO2, metal doped TiO2 or nonmetal doped TiO2 in the composition is generally from about 1 to about 10 weight % (e.g., 1 to 10 weight %).

Zein is one example for binding TiO₂. Other polymers such as epoxy, vinyl, polyurethane, acrylic, etc. in paint formulations can also be used for this purpose. Binder or resin is the main part of the paint and binds the ingredients together, thus allowing a film to be formed on a painted surface. The term “binder” includes zein and paint formulations.

We have found that compounds such as zein can be used as binder materials for TiO₂ coatings. For example, zein or paint formulations containing TiO₂ were coated on the surfaces of Petri dish (for plastic), print papers (for cellulosic materials), and metal plates. The antibacterial activity of TiO₂ coatings and their sustainability in inhibiting bacterial growth on the surface of coatings were investigated. The coating materials are designed to make microbe-free surfaces of food containers or frameworks, such as cardboard, boxes or shelves from plastics, wood, plywood, or metals. The coating suppresses or limits microorganism spreading from contaminated fruits or worker to health fruits via containers.

The compositions are applied to the surfaces of the food container. By coating the surface is meant that at least enough of the surface of the food container is covered with the composition so as to achieve the desired effect. The process of applying the composition to the surface of the food container can be done through any of the common procedures known to be effective in applying films to objects. These procedures include casting, spraying, grafting sputtering, flowing, calendaring, extruding and the like. The thickness of the coating is not as important. It can generally vary from about 1 to about 2000 microns, or from about 2 to about 1000 microns, as long as the function of the film is maintained.

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### Examples

Materials: Zein (95%), titanium dioxide (>99%; particle size<25 nm), and ethanol were purchased from Sigma-Aldrich-Fluka (St Louis, Mo.). Carbon-, nitrogen-, boron-, and fluorine-codoped TiO₂ powders were prepared according to the method reported previously (Im, J. S., et al., J. Colloid and Interface Science, 336: 183-188 (2009); Li, D., et al., Chemistry of Materials, 17: 2588-2595 (2005)). Petri dishes (85×10 mm, D×H) were from VWR (West Chester, Pa.). Regular print papers that were used for zein coating, ASPEN®30, were from local Office Depot. Normal paint (KILZ Latex; Masterchem Industries, LLC, Imperial, Mo.) was purchased from Home Depot.

Escherichia coli O157:H7 Oklahoma was obtained from the culture collection of the U.S. Department of Agriculture, Agricultural Research Service, Eastern Regional Research Center. Tryptic soy broth (TSB) was from Remel, Inc. (Lenexa, Kans.). Tryptic Soy Agar (TSA) was from Difco/Becton Dickinson (Sparks, Md.). Butterfield's phosphate buffer (pH 7.2) was from Hardy Diagnostics (Santa Maria, Calif.).

Deionized (D.I.) water was prepared by ion exchange (Millipore; Billerica, Mass.).

Coating preparation: Zein was dissolved in 85% ethanol at a concentration of 2.5% (w/v). TiO₂/zein solutions with various TiO₂ contents were prepared by dispersion of 25, 50, or 250 mg TiO₂ or doped-TiO₂ powders in 100 ml of zein solution, in which the ratios of TiO₂/zein were 1, 2, and 10 w %, respectively. For single layer coating preparation, 10 ml of each TiO₂/zein solution were evenly distributed to a petri dish followed by air-drying on bench at room temperature. For double layer TiO₂/zein coating, 8 ml of zein solutions (without TiO₂) were coated on the surface of a petri dish to form first layer, when the first layer was 80% dried (about 3 h) then 2 ml of 10% TiO₂/zein or doped-TiO₂/zein suspension were spread on the surfaces of the first zein layer to form the second layer. Petri dish coated with 10 ml zein solution was used as a control.

Zein and TiO₂/zein formulations were also used to coat the surfaces of regular print papers by dipping the papers in the formulation for 6 sec and air-drying the coated papers. In another experiment, metal plates were cut in the shape of a disk (D×H, 25×2 mm), paint and TiO₂/paint formulations (6% TiO₂) were coated on the surfaces (1.5 ml/each) followed by air drying to form a single layer coating.

Structural analysis: The structures of zein and TiO₂/zein films were examined by scanning electronic microscope (SEM). A Quanta 200 FEG SEM (FEI, Hillsboro, Oreg.) was used to collect images. Prior to examination, samples were mounted to specimen stubs and sputtered with a thin layer of gold. Samples were examined in the high vacuum/secondary electron imaging model at 5,000× and 50,000×.

Antimicrobial activity tests: Tests were carried out as reported previously (Li, W., et al., J. Food Protection, 75(12): 2234-2237 (2012)). Briefly, prior to the inoculum preparation, E. coli O157:H7 cells were grown in TSB aerobically at 37° C. for 16-18 h. Serial 10-fold dilutions were performed in sterile 0.1% peptone water and inoculated into TSB so as to achieve a population of ca. 4 log colony forming units (CFU)/ml.

Five ml of inoculum was added into each coated petri dish, which was enough to cover the surface of the petri dish. Petri dishes without any coatings served as controls. For Test 1, all samples were placed under light for 18 h. For Test 2, samples in group 1 were under light for 15 h and then in dark for 3 h, while samples in group 2 were under light for 3 h and then in dark for 15 h. Regular fluorescent light (40 W, 80 cm above the samples) inside the biohood was used for visible light irradiation. The illumination density was 11 μmol/s·m² as measured by a photometer with Quantum sensor (Li-COR, Lincoln, Nebr.).

At 3 and 18 h, 100 μl of the inoculated TSB in petri dishes was sampled. Specimens were serially diluted with sterile Butterfield's phosphate buffer (pH 7.2) and surface plated (100 μl per plate and three plates per dilution) onto TSA. Plates were incubated at 37° C. for 24 h before counting CFUs. After the first sampling, the inoculum left on each petri dish was decanted and each petri dish was washed with 10 ml sterile water once, and placed in biohood with fan on for 10 min. Then each dish had 10 ml TSA (50° C.) poured onto it and incubated at 37° C. for 24 h. Each experiment was conducted in triplicate.

The sustainability of TiO₂ coatings was examined using metal disks coated with TiO₂/paint formulations. Each coated disk (four disks for each coating) was placed in a 3.0 L beaker with 2.0 L water and stirred at 1,000 rpm for 1 min at room temperature with the aid of mechanical stirring (Cole-Parmer digital mixer; Cole-Parmer, Vernon Hills, Ill.). The distance from the tip of the stirrer to the bottom of the beaker was 10 cm. The disks were washed up to 5 times to simulate the repeated use of a food container. The metal disks were removed from the water and air-dried, and then submitted to UV irradiation for 10 min to eliminate possible microbial contamination. The disks thus treated were surface-inoculated with 50 μl of E. coli inoculum. The inoculated disks were placed into a biohood under regular fluorescent lamp as described above for 3 or 18 h. At 3 or 18 h, each disk was swept with a wet cotton tip across the entire sample surface in three different directions (0°, 45°, and 90°), and the swab tip was placed into a test tube containing 10 ml of peptone water and the tube was vortexed for 1 min. Specimens were serially diluted and surface plated onto TSA. Plates were incubated at 37° C. for 24 h before counting CFU.

Contact Angle measurement: The hydrophilicity and hydrophobicity of zein formulations were determined by measuring the contact angle with a drop of ethylene glycol in air at 25° C. using an Automated Goniometer equipped with a PC and DROP image Advanced v2.5 software (Model 590; Ramé-hart instrument co., Succasunna, N.J.). Each sample was examined at least three different locations of the film and the average was calculated.

Water vapor transmission rate (WVTR) analysis: Samples of coated and non-coated papers were pre-dried under house vacuum for 48 hours prior to testing. The WVTR was determined according to ISO 2528 (Liu, L S., et al., J. Agric. Food Chem., 55(6): 2349-2355 (2007)). Briefly, a glass container (diameter, D=5 cm) with anhydrous CaCl₂ desiccant was covered with a piece of paper or paper pre-coated with zein or zein/TiO₂, and sealed with paraffin wax. The containers were conditioned in a chamber at 100% relative humidity and at a temperature of 22°-24° C. A mini-fan was installed inside the chamber to provide air convection at 0.3 m/s to ensure uniform conditions throughout the chamber. Each container was weighed at desired time points. After the gain in mass between two successive measurements was less than 5%, the WVTR was calculated from the weight increase of the container over time according to WVTR=w/(tA), where w is the increase (mg) in mass, t (day) is the duration of the experiment, and A is the permeation area (cm²). Differences in membrane thickness were ignored in this study. Empty glass containers covered with the films were used as the control.

Statistical analysis: Antimicrobial experiments were conducted in triplicate. Data points were expressed as the mean±standard deviation. Data were analyzed using analysis of variance from SAS version 9.1 software (SAS Institute, Cary, N.C.). Duncan's multiple range tests were used to determine the significant difference of mean values. Unless stated otherwise, significance was expressed at 5% level.

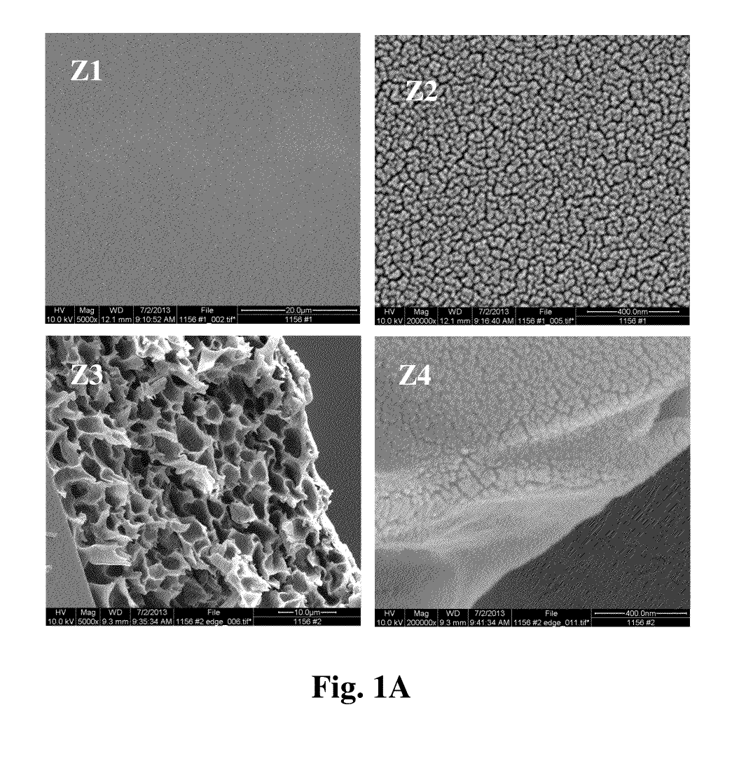

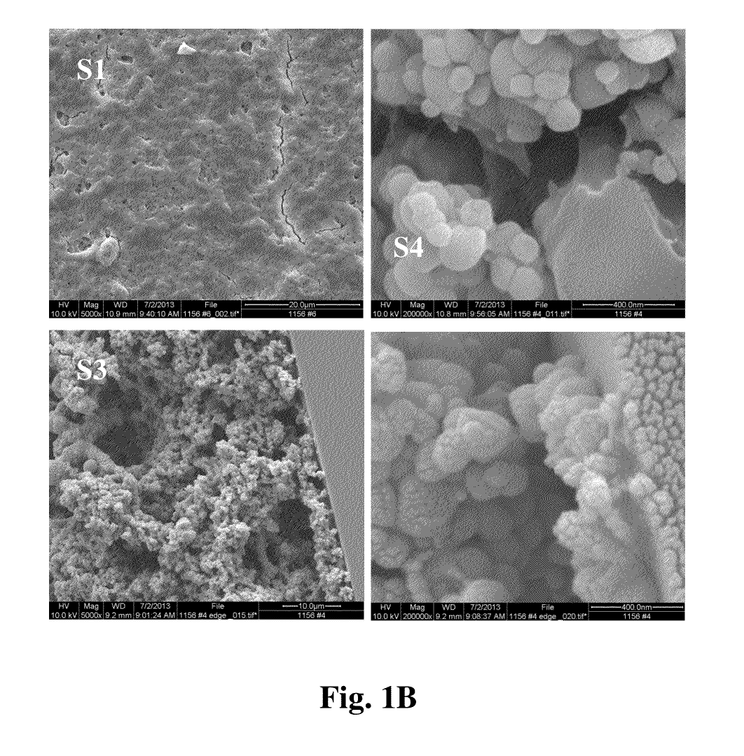

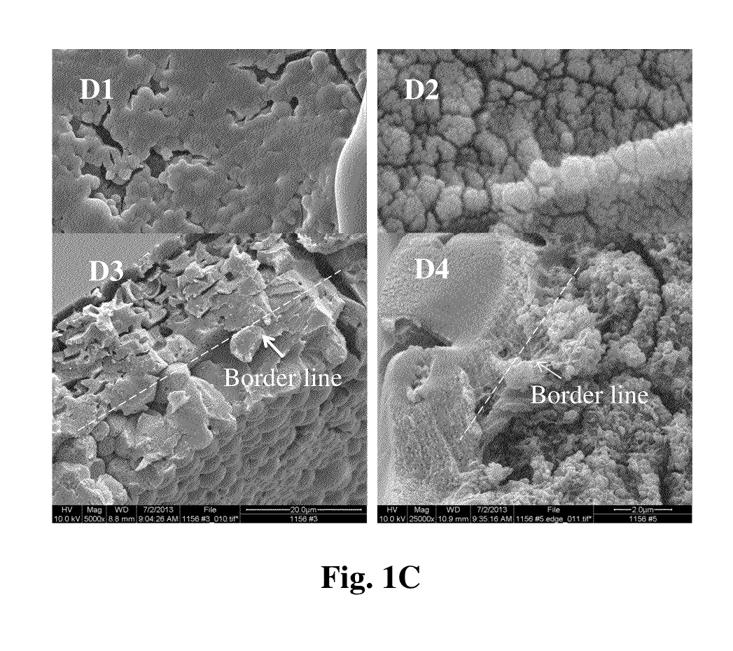

Results and discussion: In the present study, zein and normal paint were used as binder of TiO₂ powders to form a thin film on the surfaces of plastics, cellulosic products, or metal plates. SEM micrographs of the surfaces and cross-sections for neat zein films, TiO₂/zein film, and the bilayer film with neat zein on the bottom and TiO₂/zein on the top were taken and are shown in FIG. 1. The surfaces of neat zein film appear as a glossy and uniform material without pores even at 200K magnification (FIG. 1a, Z1 and Z2); its cross-section (FIG. 1a, Z3 and Z4) was dense and smooth, indicating the plastic nature of zein. The incorporation of TiO₂ nanoparticles resulted in a rough morphology (FIG. 1b, S1 and S3); TiO₂ nanoparticles appeared to be glued together to form blocks that can be observed on the surfaces (FIG. 1b, S2) and cross sections (FIG. 1b, S4) at higher magnification. As TiO₂ content in TiO₂/zein formulations increased from 1% to 10%, the size of the blocks became smaller (data not shown). Without being bound by theory, this could be attributed to the huge surface areas (200-220 m²/g) of the TiO₂ nanoparticles. At higher particle concentrations, the amount of zein present per m² of particle surface was very low, thus large blocks were difficult to be hold together. For bilayered TiO₂/zein films, a surface topography surprisingly similar to that of single layer TiO₂/zein film (FIG. 1b, S1 and S2) was clearly seen in FIG. 1c (D1 and D2). The cross-section of the bilayered films showed a neat zein like structure on the left and a TiO₂/zein like structure on the right from the border line of the two phases (FIG. 1c, D3 and D4).

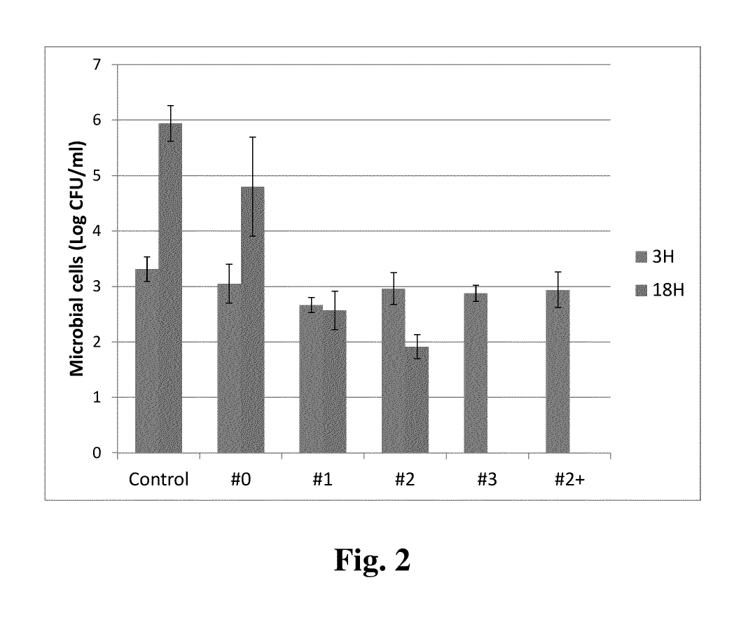

The antibacterial activity of TiO₂/zein films were evaluated by measuring the population of Escherichia coli O157:H7 on the films that coated petri dishes or metal disks. The experiments were carried out under visible light irradiation. As shown in FIG. 2, no significant changes in E. coli O157:H7 populations were observed in the first three hours of incubation, regardless if TiO₂ nanopowders were added or how they were added. A significant decrease in E. coli numbers was surprisingly observed after 18 h on TiO₂/zein films. The numbers of E. coli inoculated on zein films (Sample ^{#}0) were surprisingly less than those on non-coated petri dishes (controls), indicating E. coli suffered from growth on zein films as compared with the controls. The incorporation of TiO₂ nanopowders further suppressed bacterial growth. As the ratio of TiO₂/zein increased from 0% (sample ^{#}0) to 1% (sample ^{#}1) and 2% (sample ^{#}2), the number of E. coli decreased 1 log successively. For the zein films with 10% TiO₂ content (sample ^{#}3), no viable E. coli cells were detected (<1 log CFU/ml). Sample ^{#}2⁺ was a bilayered film with a neat zein layer on the bottom and a TiO₂/zein layer on the top. The bilayered sample ^{#}2⁺ contained the same amount of TiO₂ nanopowders (2%) as sample ^{#}2 had while the TiO₂ content in the top layer was equal to that of entire sample ^{#}3 (10%), sample ^{#}2⁺ surprisingly showed the same antibacterial activity as sample ^{#}3 did, which is much higher than sample ^{#}2 (FIG. 2). These results indicated that the antibacterial activity of TiO₂/zein films was determined by the amount of TiO₂ embedded on the surfaces. For the bilayered films, the coating materials consisted of a neat binder layer on bottom and another layer containing titanium dioxide powders on the top. Without being bound by theory, the bottom layer surprisingly facilitated the anchoring of the coating to the surfaces of stiff substrates, while the more concentrated TiO₂ powders on the top layer surprisingly functioned more efficiently in deactivating microbes.

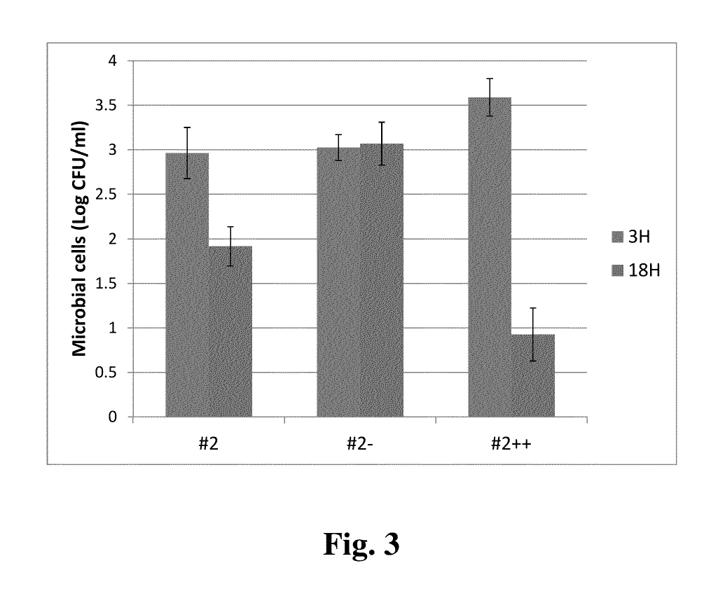

Florescent lamps are commonly used in warehouses and retail stores, and containers and shelves are usually exposed under visible light irradiation for irregular time periods. To evaluate the effect of visible light irradiation on the antimicrobial activities of TiO₂ coatings, Petri dishes coated with single layer of 2% TiO₂/zein were irradiated under two different conditions prior to antimicrobial test: one group was exposed to light for 15 h followed by placing in dark for 3 h; another group was exposed to light for 3 h followed by placing in dark for 15 h. The Petri dishes coated with doped-TiO₂/zein formulation were included in the second group and tested in comparison with TiO₂/zein coatings. As shown in FIG. 3, Sample ^{#}2 (group 1) had significantly lower E. coli populations than sample ^{#}2⁻ (group 2 coated with TiO₂/zein) after 18 h, indicating that longer time exposure to visible light enhanced the antimicrobial activity of the coatings. However, sample ^{#}2⁺⁺ (coated with doped-TiO₂/zein formulation) surprisingly reduced more E. coli cells than both sample ^{#}2 and sample ^{#}2⁻, indicating that nonmetal (C, N, B, F) codoped-TiO₂ powders possessed higher visible light-responsive antibacterial effect than non-modified TiO₂ particles.

Titanium dioxide itself has no toxicity to microbes or cells. Its strong oxidation and reduction power was realized on the discovery of the Honda-Fujishima effect in 1972 (Fujishima, A., and K. Honda, Nature, 283:37-78 (1972)). Since then titanium dioxide compounds have been developed into popularly recognized photocatalyst materials for bacterial deactivation (even with limited UV light available), resulting in a number of titanium dioxide formulations for self-cleaning and self-sterilizing applications. The photoactivation of TiO₂ is initiated by absorbing the photon with energy equal to or greater than the band gap of TiO₂ (3.2 eV). It results in a promoted electron in conduction band and a positive hole in valence band. The charged particles can react with either electron acceptors or electron donors adsorbed onto the surfaces or within the surrounding electrical layer to generate free hydroxyl radicals, superoxide radicals, or peroxide, depending on environmental conditions (Augugliaro, V., et al., J. Photochemistry and Photobiology C: Photochmistry Reviews, 13: 224-2 (2012)). These active species contribute to the pathways of bacterial destruction. The large band of excitation limits the applications of TiO₂ in living environments since more energy would be required. Recent research has revealed that modification of TiO₂ or controlled calcination can successfully narrow the band gap, thus expanding the absorption wavelength to the visible light region (thus reducing energy requirements) and shorten the irradiation period (Pelaez, M., et al., Applied Catalysis B: Environmental, 15: 331-349 (2012); Zaleska, A., Recent Patents on Engineering, 2:157-164 (2008); Grabowska, E., et al., Water Research, 46:5453-5471 (2012); Liou, J. W., and H. H. Chang, Arch. Immunol. Ther. Exp., 60(4): 267-275 (2012)). Our present experimental results with doped-TiO₂ confirmed this finding.

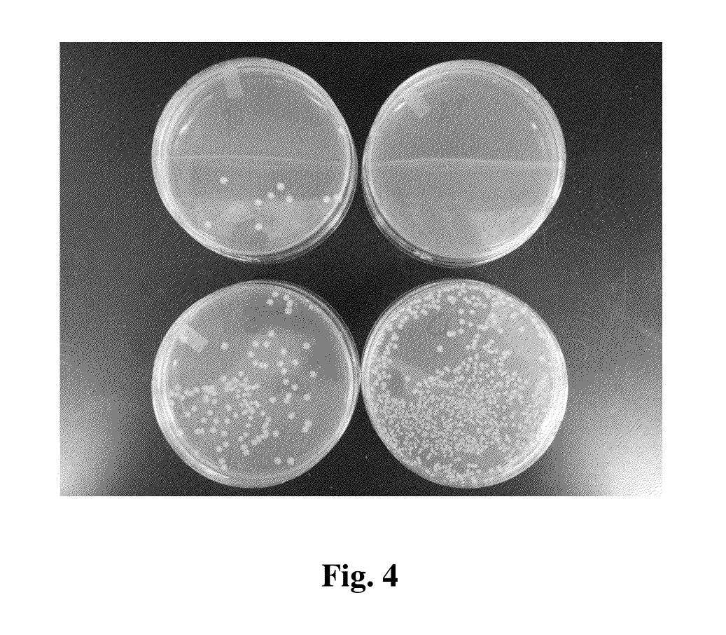

FIG. 4 shows the residual E. coli cells on the films after washing. Sample ^{#}2⁺ surprising had no colonies, Sample ^{#}2 surprisingly had 11 colonies, Sample ^{#}2⁻ had 140 colonies, and Sample ^{#}0 had over 300 colonies. This surprisingly demonstrated that the films coated with TiO₂/zein not only inhibited or reduced E. coli on their surfaces as shown in FIG. 2 and FIG. 3 but also increased the resistance to bacterial attachment and prevented biofilm forming on their surfaces.

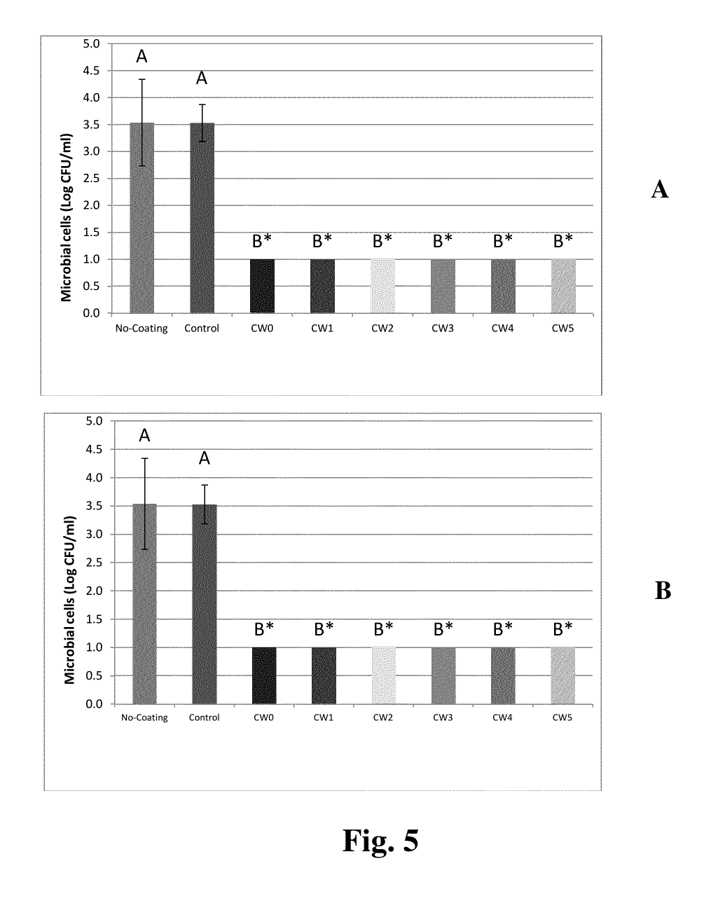

FIG. 5 shows the residual E. coli cells on the metal disks coated with a single layer TiO₂/paint and washed for 0 to 5 times. For samples exposed to light for 3 h (FIG. 5A), there were no significant differences between controls (no coating) and coated samples without TiO₂, both samples had 3-3.5 log CFU/ml E. coli cells on the surfaces. Samples coated with TiO₂ had approximated 2 log CFU/ml, thus the coating surprisingly reduced over 90% of E. coli on the disk surfaces regardless of the time length of water washing; for samples exposed to light for 18 h, the residual E. coli cells were at an undetectable level (<1.0 log CFU/ml), achieving more than 99.7% reduction. Again, there were no significant differences observed for the antimicrobial activity among samples with different water-washing times.

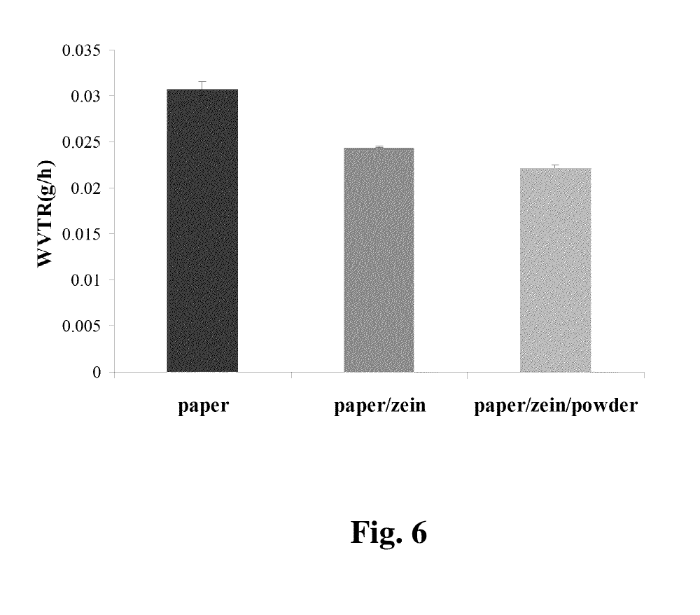

Zein has been known as a water vapor and oxygen barrier (Tihminlioglu, F., et al., Journal of Food Engineering, 96: 342-347 (2001); Han, J., et al., Journal of Agricultural and Food Chemistry, 58(5): 3125-3131 (2010)), and thus has been developed as an alternative for flexible packaging applications. In the present experiment, we evaluated the effect of the inclusion of TiO₂ powders on WVPR of zein formulations by measuring their wettability and their water vapor permeability. As shown in Table 1, the wettability of filter paper was decreased by coating with hydrophobic zein, while this was partially reduced by the incorporation of 1% hydrophilic TiO₂ powders into the zein formulation. The coating of hydrophobic zein on papers reduced water vapor diffusion (FIG. 6). The addition of 1% hydrophilic TiO₂ powders into the zein formulation further decreased the value of water vapor permeability. It has been reported that zein films can partially hydrate or swell (i.e., by immersion in aqueous solutions or by exposure to high humid environment for a long time) to form channels that facilitate mass diffusion (Lawton, J. W., Cereal Chemistry, 79:1-18 (2002)). We found that when TiO₂ powders were incorporated, these non-swellable particles limited the channel effect created by zein, and blocked the pores that permit water vapor diffusion. This barrier property of TiO₂/zein formulations is a preferable characteristic for coating substances for boxes and containers of fresh fruits and vegetable.

We have thus developed a formulation consisting of zein as matrix phase embedded with titanium dioxide powders as active component. The two-step coating procedure surprisingly allowed more active titanium dioxide powders concentrated on coating surfaces, thus higher anti-microbial activity could surprisingly be achieved. Meanwhile the TiO₂/zein coatings enhanced water resistance. Containers and frameworks, either made from paper, or plastic, or metal, coated with TiO₂/zein are expected to be able to reduce the risk of the microbiological contamination of fruits and vegetables during harvest and postharvest, and could be used in farms, food producers, warehouses, and retail-stores.

All of the references cited herein, including U.S. patents, are incorporated by reference in their entirety. Also incorporated by reference in their entirety are the following references: Corradini, E. A., et al., J. Applied Polymer Science, 101: 4133-4139 (2006); Parris, N., and D. R. Coffin, J. Agric. Food Chem., 45: 1596-1599 (1997); Lawton, J. W., Cereal Chemistry, 79: 1-18 (2002); Liu, L S., et al., Drug Delivery, 13: 417-423 (2006); Oh, Y. K., and D. Flanagan, Drug Development and industrial Pharmacy, 36(5): 497-507 (2010); Shukla, R., and M. Cheryan, Industrial Crops and Products, 13:171-192 (2001); Torres-Giner, S., et al., Food Hydrocolloid, 22:601-614 (2008); Zhang, B., et al., Biomacromolecules, 11: 2366-2375 (2010)).

Thus, in view of the above, there is described (in part) the following:

A method of producing food containers with an antimicrobial coating, said method comprising (or consisting essentially of or consisting of) (a) applying a composition comprising a binder (e.g., zein) and a carrier to a food container and drying said food container, and (b) subsequently applying to said food carrier a composition comprising a binder, a carrier, and at least one compound selected from TiO₂, metal doped TiO₂, nonmetal doped TiO₂, and mixtures thereof, and drying said food container.

The above method, wherein said the metal in metal doped TiO₂ is selected from the group consisting of Cu, Co, Ni, Cr, Mn, Mo, Nb, V, Fe, Ru, Au, Ag, Pt, and mixtures thereof.

The above method, wherein said the metal in nonmetal doped TiO₂ is selected from the group consisting of N, S, C, B, P, I, F, and mixtures thereof.

The above method, wherein said binder is zein.

The above method, wherein said carrier is ethanol.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Contact Angle Measurement

| Samples | Contact Angle (°) |
|---|---|
| Paper sheet | 70.50 ± 3.56 |
| Zein coating | 31.80 ± 2.43 |
| Zein/TiO₂ coating | 58.90 ± 2.53 |

We claim:

1. A method of producing food containers with an antimicrobial coating, said method comprising (a) applying a composition comprising zein and a carrier to a food container and drying said food container, and (b) subsequently applying to said food carrier a composition comprising a binder, a carrier, and at least one compound selected from TiO₂, metal doped TiO₂, nonmetal doped TiO₂, and mixtures thereof, and drying said food container.

2. The method according to claim 1, wherein said the metal in metal doped TiO₂ is selected from the group consisting of Cu, Co, Ni, Cr, Mn, Mo, Nb, V, Fe, Ru, Au, Ag, Pt, and mixtures thereof.

3. The method according to claim 1, wherein said the metal in nonmetal doped TiO₂ is selected from the group consisting of N, S, C, B, P, I, F, and mixtures thereof.

4. The method according to claim 1, wherein said binder is zein.

5. The method according to claim 1, wherein said carrier is ethanol.
